(19) United States
(12) Patent Application Publication
(10) Pub. No.: US 2009/0222306 A1
(43) Pub. Date: Sep. 3, 2009

(54) METHOD AND CONTROL DEVICE FOR DETERMINATION OF THE TIME DURATION BEFORE A MACHINE ELEMENT REQUIRES SERVICING

(75) Inventors: Jochen Bretschneider, Esslingen (DE); Volker Maier, Düsseldorf (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: SIEMENS AKTIENGESELLSCHAFT, 80333 MUNCHEN (DE)

(21) Appl. No.: 12/096,318

(22) PCT Filed: Nov. 17, 2006
(86) PCT No.: PCT/EP2006/068597

§ 371 Date: Sep. 26, 2008

(30) Foreign Application Priority Data
Dec. 5, 2005 (DE) 10 2005 058 038.6

(51) Int. Cl. G06Q 10/00; G06Q 50/00

(52) U.S. Cl. 705/7

(57) ABSTRACT

The invention relates to a method for determination of the time duration (T) before a machine element (6) of a machine requires servicing, comprising the following method steps: determination of a position-related load curve (BK) of the machine element (6) on the basis of a process variable (a, r) and of a position variable (x) for a manufacturing process to be evaluated, storage of the load curve (BK) for each manufacturing process to be evaluated, determination of a summation curve (SK) by addition of the stored load curves (BK) and determination of the time duration (T) before the machine element (6) requires servicing, on the basis of a separation (A) between a predetermined limit variable (GK) and the summation curve (SK). The invention also relates to a control device (12) relating to this for the machine. The invention makes it possible to determine the time duration (T) before a machine element (6) of a machine requires servicing.

The invention relates to a method for determination of the time duration before a machine element of a machine requires servicing. Furthermore, the invention relates to an associated control device of the machine.

Machines such as e.g. machine tools, production machines and/or robots are nowadays usually serviced according to a fixed service schedule because the lifetimes of the machine elements of the machine that are to be serviced are generally estimated based on experience. The service schedule stipulates what machine element has to be serviced after what operating duration (operating hours). The actual load of individual machine elements of the machine that occurred during machining is not taken into account since nowadays it is either not evaluated at all or is evaluated only inadequately. If appropriate, as a result of the fixed service schedule, machine elements are renewed to early or service intervals are made to short.

Commercially customary practice does not involve, in particular, position-related detection of the load and evaluation of machine elements. In many machine elements, however, the wear precisely is position-dependent. In commercially customary practice, e.g. a workpiece holding apparatus is driven with the aid of a rotating spindle (e.g. recirculating ball screw). During the manufacturing process, the workpiece to be machined, which is moved by the workpiece holding apparatus, is often always moved back and forth at the same position or in a defined working space, such that, in particular, the coils of the spindle wear to a particularly great extent in the region around said position, while other regions of the spindle are hardly subject to any wear. If, as is customary in series production, very often identical workpieces are machined, that is to say that the manufacturing process is repeated again and again, then the spindle will already have a high degree of wear in a region around the relevant position, while elsewhere at the spindle the latter is still virtually as new.

EP 1 136 201 B1 discloses an apparatus and a method for informing a machine operator about the need for preventive servicing.

EP 1 153 706 B1 discloses a machine tool having means for detecting the end of its lifetime.

The invention is based on the object of enabling determination of the time duration before a machine element of a machine requires servicing.

This object is achieved by means of a method for determination of the time duration before a machine element of a machine requires servicing, comprising the following method steps:
determining a position-related load curve of the machine element on the basis of a process variable and a position variable for a manufacturing process to be evaluated,
storing the load curve for each manufacturing process to be evaluated,
determining a summation curve by summation of the stored load curves and
determining the time duration before the machine element requires servicing, on the basis of a separation between a predetermined limit variable and the summation curve.

Furthermore, this object is achieved by means of a control device of a machine, wherein the control device has:
means for determining a position-related load curve of a machine element on the basis of a process variable and a position variable for a manufacturing process to be evaluated,
a memory for storing the load curves for each manufacturing process to be evaluated,
means for determining a summation curve by summation of the stored load curves, and
means for determining the time duration before the machine element requires servicing, on the basis of a separation between a predetermined limit variable and the summation curve.

Advantageous embodiments of the invention emerge from the dependent claims.

Advantageous embodiments of the method emerge analogously to the advantageous embodiment of the control device, and vice versa.

It proves to be advantageous if determining the time duration before the machine element requires servicing, on the basis of the separation between a predetermined limit variable and the summation curve, is effected by determining how many times the load curve stored last can still be added to the summation curve until the summation curve exceeds the limit variable. This enables particularly accurate determination of the time duration before the machine element requires servicing if the last manufacturing process is also repeated a number of times in the future.

Furthermore, it proves to be advantageous if determining the time duration before the machine element requires servicing, on the basis of the separation between a predetermined limit variable and the summation curve, is effected by determining how many times a load average curve determined by means of averaging over a plurality of stored load curves can still be added to the summation curve until the summation curve exceeds the limit variable. With the aid of the evaluation, it is possible to determine the time duration before the machine element requires servicing assuming an average load. This evaluation is advantageous particularly when different manufacturing processes proceed on the machine, that is to say that generally different parts are produced on the machine.

Furthermore, it proves to be advantageous that a warning message is generated if the summation curve exceeds the limit variable. The warning message makes the user aware that the machine element needs to be serviced.

Furthermore, it proves to be advantageous if determining the position-related load curve of the machine element is effected on the basis of a plurality of process variables and/or a plurality of position variables. In the case of a multiplicity of machine elements, the machine element is loaded simultaneously by a plurality of process variables, that is to say that a plurality of process variables are involved in the wear and in the progression of the wear of the machine element. This measure enables particularly good determination of the time duration before servicing is necessary.

Furthermore, it proves to be advantageous if the process variable is present in the form of a speed, an acceleration, a jerk, a force, a torque or a temperature. Speed, acceleration, jerk, force, torque or the temperature represent significant process variables that determine the wear.

Furthermore, it proves to be advantageous if the machine is embodied as a machine tool, production machine and/or as a robot since the servicing of the machine elements is cost-intensive and complicated in the case of these machines. It goes without saying, however, that the invention is also suitable for use in any other machines.

Furthermore, a computer program product, e.g. in the form of a flash card, disc or CD for the control device according to the invention, wherein the computer program product contains code sections enabling the method according to the invention to be executed proves to be advantageous.

An exemplary embodiment of the invention is illustrated in the drawing and is explained in more detail below. In this case:

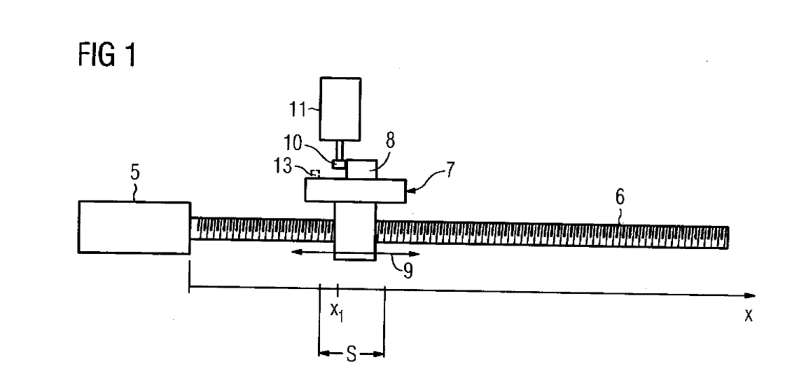

FIG. 1 shows a drive of a machine,

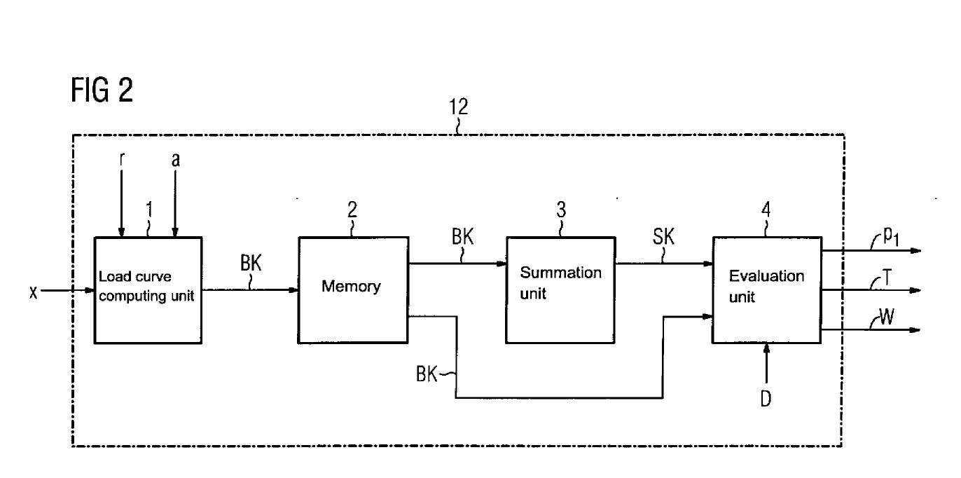

FIG. 2 shows a control device of a machine,

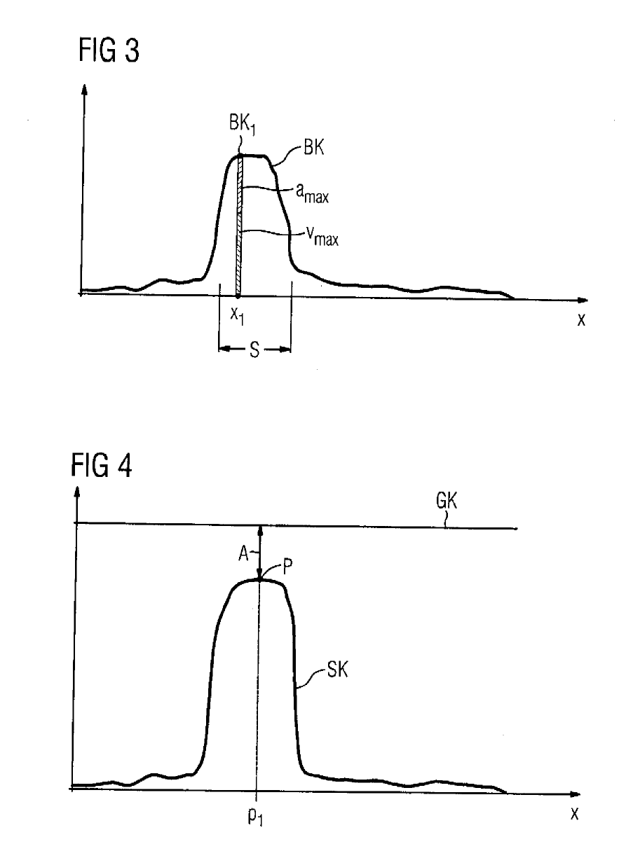

FIG. 3 shows a load curve, and

FIG. 4 shows a summation curve and a limit variable.

A commercially available drive e.g. of a machine tool is illustrated schematically in FIG. 1. In this case, a motor 5 drives a machine element in rotating fashion, said machine element being present in the form of a spindle 6 in the context of the exemplary embodiment. The rotary movement of the spindle 6 enables a workpiece holding apparatus 7 to be moved back and forth in the direction of the double-headed arrow 9. A workpiece 8 is clamped into the workpiece holding apparatus 7, said workpiece being machined by a rotating milling tool 10 driven by a motor 11.

A position variable which, in the context of the exemplary embodiment, is present in the form of a position x indicating the position of the workpiece holding apparatus 7 along the spindle 6 is determined with the aid of a measuring device, which is not illustrated for the sake of clarity.

During the manufacturing process, the workpiece holding apparatus 7 is moved particularly frequently in the region denoted by S along the spindle 6, such that a particularly high degree of wear occurs there, in particular if the same manufacturing process proceeds again and again for each new workpiece to be machined.

It should be noted at this point that, in the context of the invention, a manufacturing process should be understood to mean either an individual machining process, e.g. in the context of milling machining, or in the case of more complex manufacturing the entire manufacturing process, that is to say completely running through the workpiece-associated manufacturing program for controlling the machine.

FIG. 2 schematically illustrates a control device 12, which can be present e.g. in the form of numerical control device for controlling the machine, wherein, for the sake of clarity, only the elements of the control device 12 which are necessary for understanding the invention are illustrated.

The control device 12 has a means for determining a position-related load curve BK of a machine element on the basis of a process variable and a position variable for a manufacturing process to be evaluated, wherein the means is embodied as a load curve calculation unit 1 in the context of the exemplary embodiment. In the context of the exemplary embodiment, the two process variables jerk r and acceleration a of the workpiece holding apparatus 7 in accordance with FIG. 1, and also the position x of the workpiece holding apparatus 7 are fed to the load curve calculation unit 1. The acceleration a can be determined from the position x by double differentiation with respect to time, while the jerk r can be determined from the position x by triple differentiation with respect to time. As an alternative to this, e.g. the acceleration a can also be detected by means of an acceleration sensor 13, illustrated by dashed lines in FIG. 1. The load curve calculation unit 1 determines, as already stated, a position-related load curve GK on the basis of the two process variables acceleration a and jerk r and the position x for the manufacturing process to be evaluated.

An example of a load curve BK is illustrated in FIG. 3. This is a position-related load curve, that is to say that the load curve is plotted against the position x. In order to determine the position-related load curve BK, during the manufacturing process in the context of the exemplary embodiment for each measured position of the workpiece holding apparatus 7, the maximum acceleration aₘₐₓ measured at said position and the maximum jerk rₘₐₓ measured at said position are added and the position-related load curve BK is determined against the position x in this way. As an alternative to this, however, it is also possible for the acceleration a measured at the position and the jerk r measured at the position to be added and for the position-related load curve BK to be determined against the position x in this way. FIG. 3 illustrates the determination of the value BK₁ of the load curve BK at the position x₁ in accordance with FIG. 1. It is also conceivable, of course, for the load curve BK to be determined with only one individual process variable or with significantly more process variables, in which case, if appropriate, e.g. before the addition, the individual process variables can also be weighted if it is known, for example, that on the relevant machine element an acceleration becomes apparent to a particularly great extent in the wear, while a jerk that occurs during the movement becomes apparent to a lesser extent in the wear. Furthermore, the load curve can also be multidimensional, e.g. by the load curve being dependent on a plurality of position variables describing the position in different directions (X-, Y-, Z direction). In this way the load curve can also be present in the form of an area or a three- or higher-dimensional body.

The weighting described above can e.g. also incorporate how long the respective process variable at the relevant position has affected the machine element.

The position-related load curve BK determined in this way is subsequently stored for each manufacturing process to be evaluated, that is to say each manufacturing process that is to be used for determining the time duration before the machine element requires servicing, in a memory 2 (see FIG. 2). If appropriate, therefore it is not absolutely necessary to include all the manufacturing processes in the method.

This is followed, by mean of a means for determining a summation curve SK, by determining the summation curve SK by summation of the load curve BK stored in the memory 2. In the context of the exemplary embodiment, the means for determining the summation curve SK is embodied in the form of a summation unit 3 in accordance with FIG. 2. FIG. 4 illustrates the summation curve SK, wherein the summation unit 3 is reset, that is to say that the value of the summation curve is set to zero, if the machine element to be considered is replaced e.g. by a new machine element.

The summation curve SK determined in this way is subsequently fed as input variable to a means for determining the time duration T before the machine element requires servicing, which is embodied in the form of the evaluation unit 4 in the context of the exemplary embodiment (see FIG. 2). The evaluation unit 4 determines the time duration T before the machine element, that is to say the spindle 6 in the exemplary embodiment, requires servicing, on the basis of a separation A between a predetermined limit variable GK and the summation curve SK. The separation A, the summation curve SK and the limit variable GK are illustrated in FIG. 4. In this case, in the context of the exemplary embodiment, the limit variable GK is embodied as a constant location-independent limit value. However, the limit variable GK can also be embodied as a position-dependent limit curve. In the context of the exemplary embodiment, the separation A results from the difference between the limit variable GK and a maximum value P of the summation curve SK.

Various evaluation possibilities exist for determining the time duration T, wherein said evaluation possibilities can be carried out alternatively or else in parallel in the evaluation unit 4.

In one instance, determining the time duration T before the machine element requires servicing, on the basis of the separation A between the predetermined limit variable GK and the summation curve SK, can be effected by determining how many times the load curve stored last can still be added to the summation curve SK until the summation curve SK exceeds the limit variable GK. On the basis of the number N—determined in this way—of manufacturing processes to be evaluated which can still be carried out before the summation curve SK exceeds the limit variable GK and from knowledge of the temporal duration D of each manufacturing process to be evaluated (e.g. on the basis of the temporal duration for processing a manufacturing program), it is easily possible, e.g. by multiplying these two variables, to determine the time duration T until the limit variable GK is exceeded (that is to say e.g. in the simplest case T=N*D assuming that all the manufacturing processes still to come have the same temporal duration D) and a necessary servicing of the machine element thus becomes necessary. In this case, the limit variable GK is predetermined for the machine element that is respectively to be considered.

A further evaluation possibility consists in the fact that determining the time duration T before the machine element 6 requires servicing, on the basis of the separation between a predetermined variable and the summation curve, is effected by determining how many times a load average curve determined by means of averaging over a plurality of stored load curves BK can still be added to the summation curve until the summation curve exceeds the limit variable. This form of evaluation is suitable particularly if different manufacturing processes e.g. for the production of different workpieces take place on a machine and the individual manufacturing processes impose different degrees of loading on the machine element to be considered. The evaluation unit 4 outputs to the user the time duration T before the machine element requires servicing, said evaluation unit assuming an average duration D′ of the manufacturing processes that are still to come. The average duration D′ results e.g. by averaging over a plurality of stored durations D of different manufacturing processes.

Furthermore, the evaluation unit 4 outputs a warning message W if the summation curve exceeds the limit variable and immediate servicing of the machine element is necessary.

Furthermore, it should be noted at this point that the process variables can be present e.g. in the form of a speed, an acceleration of a jerk, a force of a torque, a temperature or any other variables of whatever configuration which are either e.g. determined within the control device or are detected by means of a sensor system.

In this case, the evaluation can be realized not just within the control device 12 as in the exemplary embodiment, rather the load curves stored in the memory 2 can also be read out e.g. by means of an external computer and an evaluation for determining the time duration T before the machine element requires servicing can also be effected on the external computer.

Furthermore, the position p₁ at which there is the highest load, i.e. the summation curve has its maximum value P, can also be output alongside the time duration T. This enables the user e.g. to shift future manufacturing processes to a different position on the spindle 6 and in this way to prolong the time duration T before the machine element, i.e. the spindle 6 in this case, requires servicing or to distribute the wear of the spindle uniformly over the length of the spindle. In this case, however, shifting the manufacturing process can also be carried out by the machine in an automated manner.

It should furthermore also be noted at this point that, of course, the term position-related should be understood to mean not just in a linear direction but also in a rotary direction. Thus, e.g. the position of the load curve can also be related to an angle of rotation of a gearwheel or of a rotary motor.

1-9. (canceled)

10. A method for determination of a time duration before a machine element of a machine requires servicing, comprising the following method steps:
determining a position-related load curve of the machine element based on a process variable and a position variable for one or more manufacturing processes to be evaluated;
storing the load curve for each manufacturing process to be evaluated;
adding the stored load curves and determining a summation curve;
determining a separation between a predetermined limit value and the summation curve; and
determining from the separation the time duration before the machine element requires servicing.

11. The method of claim 10, wherein determining the time duration further comprises the step of determining a number of times a stored load curve of the last manufacturing process can be added to the summation curve, before the summation curve exceeds the predetermined limit value.

12. The method of claim 10, wherein determining the time duration further comprises the steps of computing a load average curve as an average of the stored load curves, and determining a number of times the load average curve can be added to the summation curve, before the summation curve exceeds the predetermined limit value.

13. The method of claim 10, further comprising the step of generating a warning message if the summation curve exceeds the predetermined limit value.

14. The method of claim 10, wherein the position-related load curve is determined from more than one process variable or more than one position variable, or both.

15. The method of claim 10, wherein the process variable is selected from the group consisting of speed, acceleration, jerk, force, torque and temperature.

16. The method of claim 10, wherein the machine is a machine tool, a production machine or a robot, or a combination thereof.

17. A control device of a machine, comprising:
means for determining a position-related load curve of the machine element based on a process variable and a position variable for one or more manufacturing processes to be evaluated;
a memory for storing the load curve for each manufacturing process to be evaluated;
means for adding the stored load curves to determine a summation curve; and
means for determining a separation between a predetermined limit value and the summation curve and for determining from the separation the time duration before the machine element requires servicing.

18. A computer program embodied on a computer-readable medium and containing code sections, which when loaded into memory of a computer, causes the computer to determine a time duration before a machine element of a machine requires servicing by:
determining a position-related load curve of the machine element based on a process variable and a position variable for one or more manufacturing processes to be evaluated,
storing the load curve for each manufacturing process to be evaluated,
adding the stored load curves and determining a summation curve,
determining a separation between a predetermined limit value and the summation curve, and
determining from the separation the time duration before the machine element requires servicing.
